(19) United States
(12) Patent Application Publication
(10) Pub. No.: US 2026/0094343 A1
(43) Pub. Date: Apr. 2, 2026

(54) ACCELERATING BOUNDING VOLUME HIERARCHY CONSTRUCTION WITH MACHINE LEARNING

(71) Applicant: Advanced Micro Devices, Inc., Santa Clara, CA (US)

(72) Inventors: Carsten Benthin, Munich (DE); Daniel Meister, Tokyo (JP)

(73) Assignee: Advanced Micro Devices, Inc., Santa Clara, CA (US)

(21) Appl. No.: 18/899,039

(22) Filed: Sep. 27, 2024

(51) Int. Cl. G06T 15/06; G06T 15/80

(52) U.S. Cl. CPC G06T 15/06; G06T 15/80

(57) ABSTRACT

Techniques herein involve building bounding volume hierarchies for ray tracing using neural networks. Bottom-up BVH building techniques include nearest neighbor search operations and tree construction operations. The nearest neighbor search operations evaluate a set of candidate nodes that do not have any parents to identify nearest neighbor pairs and the tree construction operations “combine” the nearest neighbor pairs by generating new nodes that are parents of the nodes of the pairs. The nearest neighbor search is an expensive operation as it generally considers all possible combinations of the set to select one considered “best.” A neural network model is thus proposed herein which can perform this nearest neighbor search in a more efficient manner. Specifically, the neural network model accepts, as input, information characterizing the nodes of a set for which a search is performed and provides, as output, information characterizing the nearest neighbor pairs found for the set.

### BACKGROUND

In image synthesis, ray tracing is utilized to find a nearest intersection of a given ray with a scene where light propagation is simulated. Advances in ray tracing are frequently being made.

### BRIEF DESCRIPTION OF THE DRAWINGS

A more detailed understanding can be had from the following description, given by way of example in conjunction with the accompanying drawings wherein:

FIG. 1 is a block diagram of an example device in which one or more features of the disclosure can be implemented;

FIG. 2 is a block diagram of the device of FIG. 1, illustrating additional detail, according to an example;

FIG. 3 illustrates a ray tracing pipeline for rendering graphics using a ray tracing technique, according to an example;

FIG. 4 is an illustration of a bounding volume hierarchy (“BVH”), according to an example;

FIG. 5 is a block diagram of a system for building a BVH, according to an example;

FIG. 6 is an illustration of an operation for building a BVH, according to an example;

FIG. 7 illustrates an example nearest neighbor search, according to an example;

FIG. 8 illustrates an example machine learning model that accepts candidate nearest neighbors and outputs information indicating, according to an example;

FIG. 9 illustrates an example BVH built using techniques described herein; and

FIG. 10 is a flow diagram of a method 1000 for generating a BVH, according to an example.

### DETAILED DESCRIPTION

Ray tracing is a rendering technique whereby rays are cast into a scene and pixels of a render target are colored based on which objects the rays intersect. To speed such operations up, a ray tracing system typically builds an acceleration structure such as a bounding volume hierarchy (“BVH”). Such a structure has a hierarchy of levels, where each level can include bounding volumes that bound the geometry of lower levels.

Building a BVH is an expensive process, usually requiring consideration of multiple alternatives per branching path and complex calculations. Techniques are thus provided herein for using trained neural networks to generate BVHs.

Bottom-up BVH building techniques include nearest neighbor search operations and tree construction operations. The nearest neighbor search operations evaluate a set of candidate nodes that do not have any parents to identify nearest neighbor pairs and the tree construction operations “combine” the nearest neighbor pairs by generating a new node that is the parent of the nodes of the pair.

The nearest neighbor search is an expensive operation as it generally considers all possible combinations of the set to select one considered “best.” A neural network model is thus proposed herein which can perform this nearest neighbor search in a more efficient manner. Specifically, the neural network model accepts, as input, information characterizing the nodes of a set for which a search is performed and provides, as output, information characterizing the nearest neighbor pairs found for the set. In some examples, such a model is trained using information from BVHs built using any technically feasible BVH build operation. In some examples, the input information includes a bounding volume for each node, where the bounding volume is defined with a minimum and maximum value for each axis. In some examples, the output includes, for each node, an indication of which other node of the set is considered to meet a nearest neighbor threshold. If the information for any two nodes indicate that the other meets a nearest neighbor threshold, then those two nodes are part of a nearest neighbor pair. A subsequent tree building operation generates a parent for each such nearest neighbor pair and continues building the BVH until a root node is formed (e.g., until only one node is missing a parent).

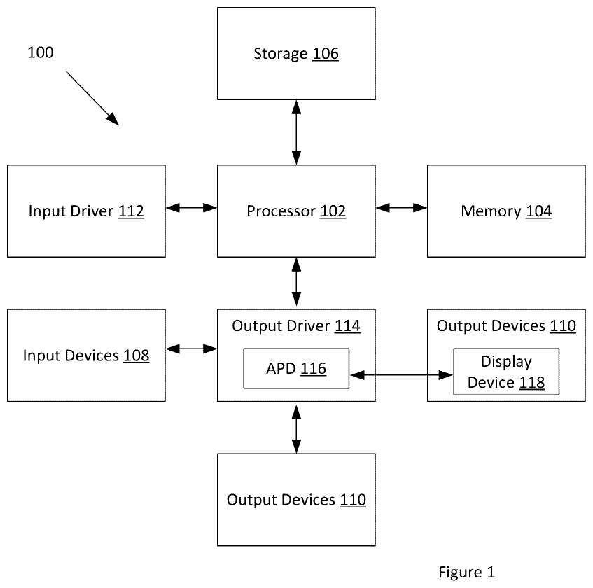

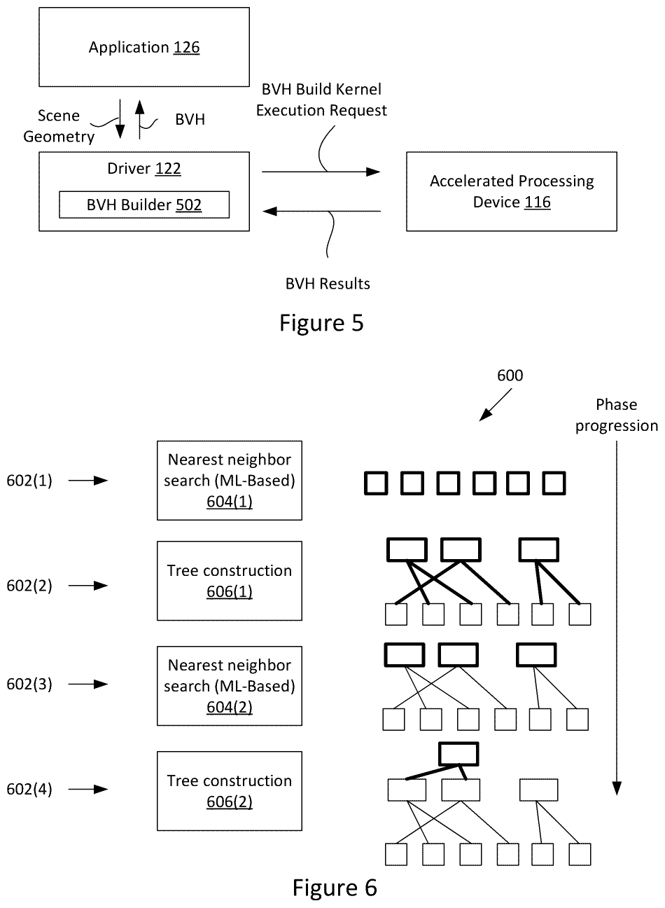

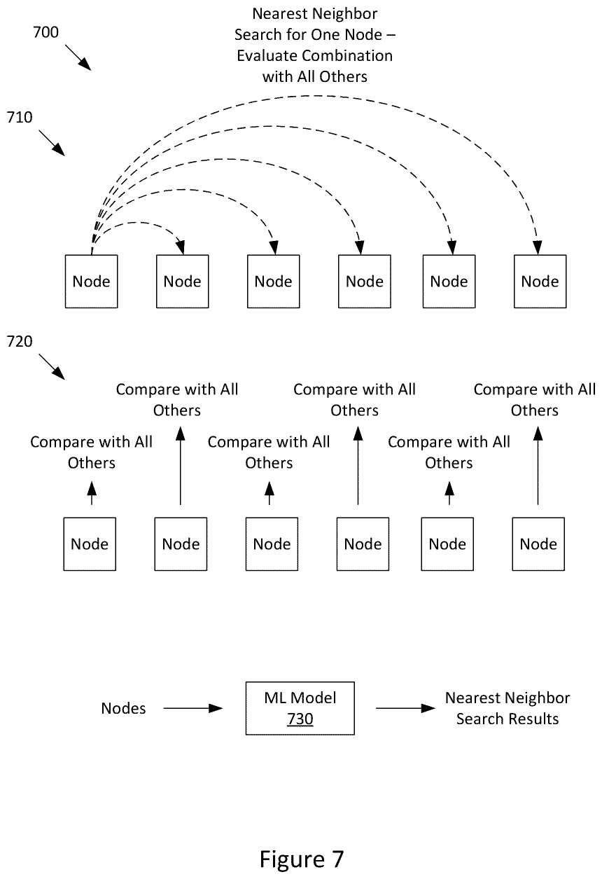

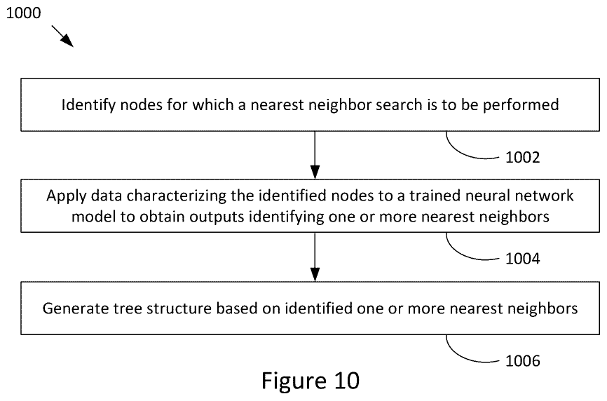

In the present disclosure, FIGS. 1-4 provide background for ray tracing. FIGS. 5 and 6 illustrate BVH building operations generally. FIGS. 7-9 illustrate neural network operations for performing a nearest neighbor search. FIG. 10 is a flow diagram of a method for building a BVH.

FIG. 1 is a block diagram of an example device 100 in which one or more features of the disclosure can be implemented. The device 100 can include, for example, a computer, a gaming device, a handheld device, a set-top box, a television, a mobile phone, server, a tablet computer or other types of computing devices. The device 100 includes a processor 102, a memory 104, a storage 106, one or more input devices 108, and one or more output devices 110. The device 100 can also optionally include an input driver 112 and an output driver 114. It is understood that the device 100 can include additional components not shown in FIG. 1.

In various alternatives, the processor 102 includes a central processing unit (CPU), a graphics processing unit (GPU), a CPU and GPU located on the same die, or one or more processor cores, wherein each processor core can be a CPU or a GPU. In various alternatives, the memory 104 is located on the same die as the processor 102, or is located separately from the processor 102. The memory 104 includes a volatile or non-volatile memory, for example, random access memory (RAM), dynamic RAM, or a cache.

The storage 106 includes a fixed or removable storage, for example, a hard disk drive, a solid-state drive, an optical disk, or a flash drive. The input devices 108 include, without limitation, a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 include, without limitation, a display device 118, a display connector/interface (e.g., an HDMI or DisplayPort connector or interface for connecting to an HDMI or Display Port compliant device), a speaker, a printer, a haptic feedback device, one or more lights, an antenna, or a network connection (e.g., a wireless local area network card for transmission and/or reception of wireless IEEE 802 signals).

The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. It is noted that the input driver 112 and the output driver 114 are optional components, and that the device 100 will operate in the same manner if the input driver 112 and the output driver 114 are not present. The output driver 116 includes an accelerated processing device (“APD”) 116 which is coupled to a display device 118. The APD accepts compute commands and graphics rendering commands from processor 102, processes those compute and graphics rendering commands, and provides pixel output to display device 118 for display. As described in further detail below, the APD 116 includes one or more parallel processing units to perform computations in accordance with a parallel processing paradigm, such as a single-instruction-multiple-data (“SIMD”) paradigm or a single-instruction-multiple-threads (“SIMT”). Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and provides graphical output to a display device 118. For example, it is contemplated that any processing system that performs processing tasks in accordance with a parallel processing paradigm may perform the functionality described herein. Alternatively, it is contemplated that computing systems that do not perform processing tasks in accordance with a parallel processing paradigm can also perform the functionality described herein.

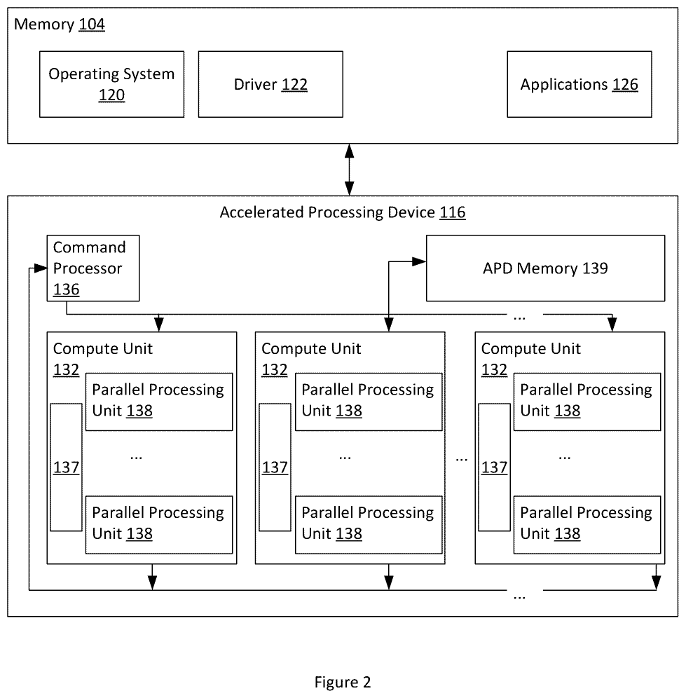

FIG. 2 is a block diagram of aspects of device 100, illustrating additional details related to execution of processing tasks on the APD 116. The processor 102 maintains, in system memory 104, one or more control logic modules for execution by the processor 102. The control logic modules include an operating system 120, a kernel mode driver 122, and applications 126. These control logic modules control various features of the operation of the processor 102 and the APD 116. For example, the operating system 120 directly communicates with hardware and provides an interface to the hardware for other software executing on the processor 102. The kernel mode driver 122 controls operation of the APD 116 by, for example, providing an application programming interface (“API”) to software (e.g., applications 126) executing on the processor 102 to access various functionality of the APD 116. The kernel mode driver 122 also includes a just-in-time compiler that compiles programs for execution by processing components (such as the parallel processing units 138 discussed in further detail below) of the APD 116.

The APD 116 executes commands and programs for selected functions, such as graphics operations and non-graphics operations that are or can be suited for parallel processing. The APD 116 can be used for executing graphics pipeline operations such as pixel operations, geometric computations, and rendering an image to display device 118 based on commands received from the processor 102. The APD 116 also executes compute processing operations that are not directly related to graphics operations, such as operations related to video, physics simulations, computational fluid dynamics, or other tasks, based on commands received from the processor 102.

The APD 116 includes compute units 132 that include one or more parallel processing unit 138 that perform operations at the request of the processor 102 in a parallel manner according to a parallel processing paradigm, such as SIMD or SIMT. In such paradigms, multiple processing elements execute the same instruction across multiple data elements or threads. The multiple processing elements share a single program control flow unit and program counter and thus execute the same program but are able to execute that program with or using different data. In one example, each parallel processing unit 138 includes sixteen lanes, where each lane executes the same instruction at the same time as the other lanes in the parallel processing unit 138 but can execute that instruction with different data. Lanes can be switched off with predication if not all lanes need to execute a given instruction. Predication can also be used to execute programs with divergent control flow. More specifically, for programs with conditional branches or other instructions where control flow is based on calculations performed by an individual lane, predication of lanes corresponding to control flow paths not currently being executed, and serial execution of different control flow paths allows for arbitrary control flow.

The basic unit of execution in compute units 132 is a work-item. Each work-item represents a single instantiation of a program or kernel that is to be executed in parallel according to the parallel processing paradigm employed. For example, in a SIMD architecture, multiple work-items execute the same instruction simultaneously on different data elements. Work-items can be executed simultaneously as a “wavefront” on a parallel processing unit 138, where each work-item executes the same instruction with different data and where different work-items can execute a different control flow path through the use of predication. In a SIMT architecture, work-items correspond to threads that can be executed simultaneously on the parallel processing unit 138, where different threads can execute different control flow paths. Threads are grouped into “warps” or “wavefronts”, which are scheduled or executed together.

For the purposes of this description, the term “wavefront” will be used, but it should be understood that this term broadly describes work-items that can be executed simultaneously and is inclusive of both “wavefronts” and “warps. One or more wavefronts are included in a “work group,” which includes a collection of work-items designated to execute the same program. A work group can be executed by executing each of the wavefronts that make up the work group. In alternatives, the wavefronts are executed sequentially on a single parallel processing unit 138 or partially or fully in parallel on different parallel processing unit 138. Wavefronts can be thought of as the largest collection of work-items that can be executed simultaneously on a single parallel processing unit 138. Thus, if commands received from the processor 102 indicate that a particular program is to be parallelized to such a degree that the program cannot execute on a single parallel processing unit 138 simultaneously, then that program is broken up into wavefronts which are parallelized on two or more parallel processing units 138 or serialized on the same parallel processing unit 138 (or both parallelized and serialized as needed). A scheduler 136 performs operations related to scheduling various wavefronts on different compute units 132 and parallel processing units 138.

The parallelism afforded by the compute units 132 is suitable for graphics related operations such as pixel value calculations, vertex transformations, and other graphics operations and non-graphics operations (sometimes known as “compute” operations). Thus in some instances, a graphics pipeline 134, which accepts graphics processing commands from the processor 102, provides computation tasks to the compute units 132 for execution in parallel.

The compute units 132 are also used to perform computation tasks not related to graphics or not performed as part of the “normal” operation of a graphics pipeline 134 (e.g., custom operations performed to supplement processing performed for operation of the graphics pipeline 134). An application 126 or other software executing on the processor 102 transmits programs that define such computation tasks to the APD 116 for execution.

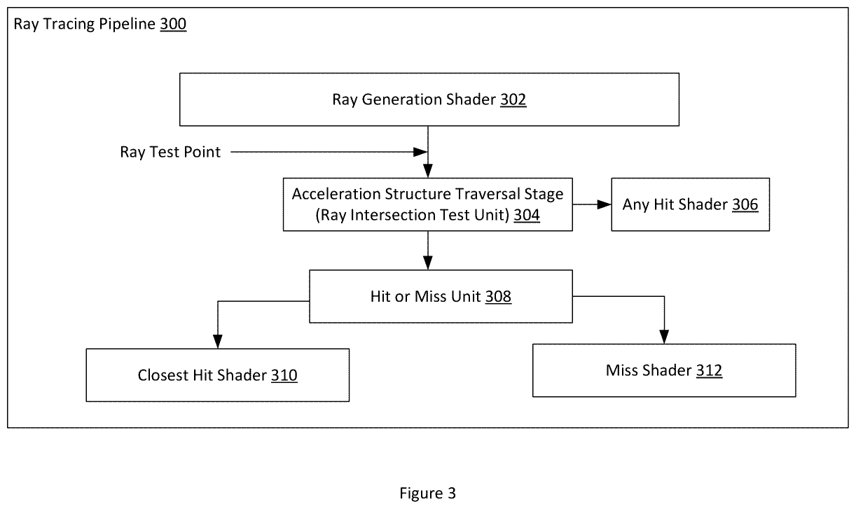

FIG. 3 illustrates a ray tracing pipeline 300 for rendering graphics using a ray tracing technique, according to an example. The ray tracing pipeline 300 provides an overview of operations and entities involved in rendering a scene utilizing ray tracing. A ray generation shader 302, any hit shader 306, closest hit shader 310, and miss shader 312 are shader-implemented stages that represent ray tracing pipeline stages whose functionality is performed by shader programs executing in the SIMD unit 138. Any of the specific shader programs at each particular shader-implemented stage are defined by application-provided code (i.e., by code provided by an application developer that is pre-compiled by an application compiler and/or compiled by the driver 122). The acceleration structure traversal stage 304 performs a ray intersection test to determine whether a ray hits a triangle.

The various programmable shader stages (ray generation shader 302, any hit shader 306, closest hit shader 310, miss shader 312) are implemented as shader programs that execute on the SIMD units 138. The acceleration structure traversal stage 304 is implemented in software (e.g., as a shader program executing on the SIMD units 138), in hardware, or as a combination of hardware and software. The hit or miss unit 308 is implemented in any technically feasible manner, such as as part of any of the other units, implemented as a hardware accelerated structure, or implemented as a shader program executing on the SIMD units 138. The ray tracing pipeline 300 may be orchestrated partially or fully in software or partially or fully in hardware, and may be orchestrated by the processor 102, the scheduler 136, by a combination thereof, or partially or fully by any other hardware and/or software unit. The term “ray tracing pipeline processor” used herein refers to a processor executing software to perform the operations of the ray tracing pipeline 300, hardware circuitry hard-wired to perform the operations of the ray tracing pipeline 300, or a combination of hardware and software that together perform the operations of the ray tracing pipeline 300.

The ray tracing pipeline 300 operates in the following manner. A ray generation shader 302 is executed. The ray generation shader 302 sets up data for a ray to test against a triangle and requests the acceleration structure traversal stage 304 test the ray for intersection with triangles.

The acceleration structure traversal stage 304 traverses an acceleration structure, which is a data structure that describes a scene volume and objects (such as triangles) within the scene, and tests the ray against triangles in the scene. In various examples, the acceleration structure is a bounding volume hierarchy. The hit or miss unit 308, which, in some implementations, is part of the acceleration structure traversal stage 304, determines whether the results of the acceleration structure traversal stage 304 (which may include raw data such as barycentric coordinates and a potential time to hit) actually indicates a hit. For triangles that are hit, the ray tracing pipeline 300 triggers execution of an any hit shader 306. Note that multiple triangles can be hit by a single ray. It is not guaranteed that the acceleration structure traversal stage will traverse the acceleration structure in the order from closest-to-ray-origin to farthest-from-ray-origin. The hit or miss unit 308 triggers execution of a closest hit shader 310 for the triangle closest to the origin of the ray that the ray hits, or, if no triangles were hit, triggers a miss shader.

Note, it is possible for the any hit shader 306 to “reject” a hit from the ray intersection test unit 304, and thus the hit or miss unit 308 triggers execution of the miss shader 312 if no hits are found or accepted by the ray intersection test unit 304. An example circumstance in which an any hit shader 306 may “reject” a hit is when at least a portion of a triangle that the ray intersection test unit 304 reports as being hit is fully transparent. Because the ray intersection test unit 304 only tests geometry, and not transparency, the any hit shader 306 that is invoked due to a hit on a triangle having at least some transparency may determine that the reported hit is actually not a hit due to “hitting” on a transparent portion of the triangle. A typical use for the closest hit shader 310 is to color a material based on a texture for the material. A typical use for the miss shader 312 is to color a pixel with a color set by a skybox. It should be understood that the shader programs defined for the closest hit shader 310 and miss shader 312 may implement a wide variety of techniques for coloring pixels and/or performing other operations.

A typical way in which ray generation shaders 302 generate rays is with a technique referred to as backwards ray tracing. In backwards ray tracing, the ray generation shader 302 generates a ray having an origin at the point of the camera. The point at which the ray intersects a plane defined to correspond to the screen defines the pixel on the screen whose color the ray is being used to determine. If the ray hits an object, that pixel is colored based on the closest hit shader 310. If the ray does not hit an object, the pixel is colored based on the miss shader 312. Multiple rays may be cast per pixel, with the final color of the pixel being determined by some combination of the colors determined for each of the rays of the pixel. As described elsewhere herein, it is possible for individual rays to generate multiple samples, which each sample indicating whether the ray hits a triangle or does not hit a triangle. In an example, a ray is cast with four samples. Two such samples hit a triangle and two do not. The triangle color thus contributes only partially (for example, 50%) to the final color of the pixel, with the other portion of the color being determined based on the triangles hit by the other samples, or, if no triangles are hit, then by a miss shader.

It is possible for any of the any hit shader 306, closest hit shader 310, and miss shader 312, to spawn their own rays, which enter the ray tracing pipeline 300 at the ray test point. These rays can be used for any purpose. One common use is to implement environmental lighting or reflections. In an example, when a closest hit shader 310 is invoked, the closest hit shader 310 spawns rays in various directions. For each object, or a light, hit by the spawned rays, the closest hit shader 310 adds the lighting intensity and color to the pixel corresponding to the closest hit shader 310. It should be understood that although some examples of ways in which the various components of the ray tracing pipeline 300 can be used to render a scene have been described, any of a wide variety of techniques may alternatively be used.

As described above, the determination of whether a ray hits an object is referred to herein as a “ray intersection test.” The ray intersection test involves shooting a ray from an origin and determining whether the ray hits a triangle and, if so, what distance from the origin the triangle hit is at. For efficiency, the ray tracing test uses a representation of space referred to as a bounding volume hierarchy. This bounding volume hierarchy is the “acceleration structure” described above. In a bounding volume hierarchy, each non-leaf node represents an axis aligned bounding box that bounds the geometry of all children of that node. In an example, the base node represents the maximal extents of an entire region for which the ray intersection test is being performed. In this example, the base node has two children that each represent mutually exclusive axis aligned bounding boxes that subdivide the entire region. Each of those two children has two child nodes that represent axis aligned bounding boxes that subdivide the space of their parents, and so on. Leaf nodes represent a triangle against which a ray test can be performed. It should be understood that where a first node points to a second node, the first node is considered to be the parent of the second node.

The bounding volume hierarchy data structure allows the number of ray-triangle intersections (which are complex and thus expensive in terms of processing resources) to be reduced as compared with a scenario in which no such data structure were used and therefore all triangles in a scene would have to be tested against the ray. Specifically, if a ray does not intersect a particular bounding box, and that bounding box bounds a large number of triangles, then all triangles in that box can be eliminated from the test. Thus, a ray intersection test is performed as a sequence of tests of the ray against axis-aligned bounding boxes, followed by tests against triangles.

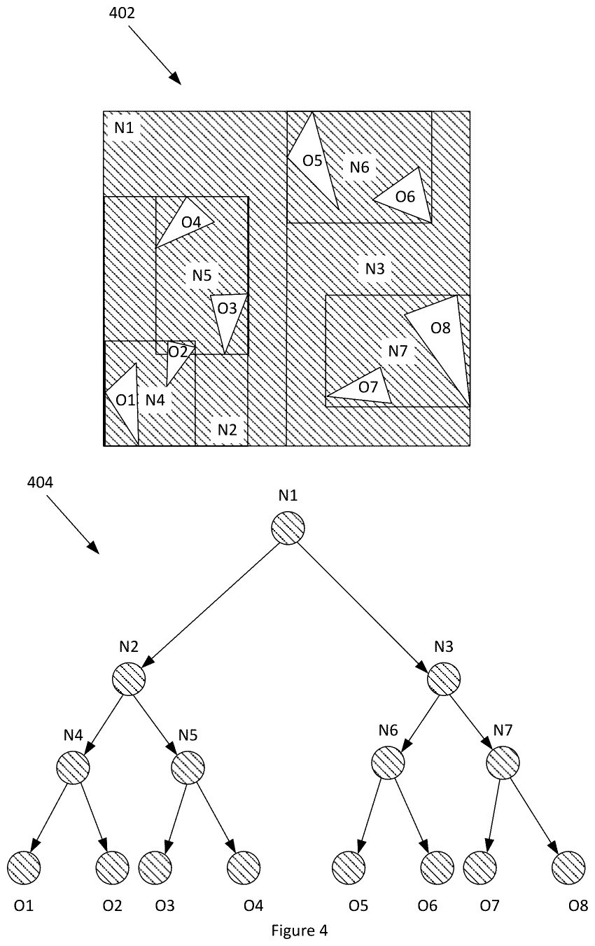

FIG. 4 is an illustration of a bounding volume hierarchy, according to an example. For simplicity, the hierarchy is shown in 2D. However, extension to 3D is simple, and it should be understood that the tests described herein would generally be performed in three dimensions.

The spatial representation 402 of the bounding volume hierarchy is illustrated in the left side of FIG. 4 and the tree representation 404 of the bounding volume hierarchy is illustrated in the right side of FIG. 4. The non-leaf nodes are represented with the letter “N” and the leaf nodes are represented with the letter “O” in both the spatial representation 402 and the tree representation 404. A ray intersection test would be performed by traversing through the tree 404, and, for each non-leaf node tested, eliminating branches below that node if the box test for that non-leaf node fails. For leaf nodes that are not eliminated, a ray-triangle intersection test is performed to determine whether the ray intersects the triangle at that leaf node.

In an example, the ray intersects O₅ but no other triangle. The test would test against N₁, determining that that test succeeds. The test would test against N₂, determining that the test fails (since O₅ is not within N₁). The test would eliminate all sub-nodes of N₂ and would test against N₃, noting that that test succeeds. The test would test N₆ and N₇, noting that N₆ succeeds but N₇ fails. The test would test O₅ and O₆, noting that O₅ succeeds but O₆ fails. Instead of testing 8 triangle tests, two triangle tests (O₅ and O₆) and five box tests (N₁, N₂, N₃, N₆, and N₇) are performed.

As just stated, in order to perform ray tracing operations, the ray tracing pipeline 300 uses one or more bounding volume hierarchies (“BVHs”) that act as an acceleration structure for accessing the geometry of a scene. In applications such as video games, simulations, or other real-time applications, geometry of the scene changes frequently such as at every frame. Thus, to have appropriate information for ray tracing, the ray tracing pipeline 300 or other entity such as the driver 122 or an application 126 must build a BVH quite frequently. Such an operation is an expensive one. Thus, efficient techniques for BVH construction are desirable.

The present disclosure provides techniques for building BVHs using machine learning. Specifically, the techniques utilize trained machine learning models to perform a nearest neighbor search, which is an operation used to combine nodes for a hierarchy in many types of BVH building algorithms. In some examples, a BVH build algorithm builds a BVH by repeatedly forming levels of the BVH. Each level includes a set of nodes—leaf nodes or non-leaf nodes. The build algorithm evaluates two or more of the nodes of a BVH under construction that do not yet have a parent using a nearest neighbor search. For any such nodes that are considered nearest neighbors, the BVH build algorithm combines those nodes, resulting in a new parent node whose children are the two nodes being combined. By repeating this operation, the BVH build algorithm builds up the BVH level by level to form a full BVH from an original set of leaf nodes.

It is possible to perform the nearest neighbor search using a trained machine learning model. Inputs to such a model would include the nodes being queried while outputs from the model would be one or more indications of which nodes are considered nearest neighbors. A training operation trains such models to generate nearest neighbor results given nodes to be combined.

FIG. 5 is a block diagram of a system for building a BVH, according to an example. The system includes a BVH builder 502 which accepts scene geometry and generates a constructed BVH. In some examples, the BVH builder 502 is part of a driver 122 that executes on the processor 102. In some examples, the BVH builder 502 also executes at least partially on the APD 116. In some such examples, the BVH builder 502 generates requests to execute kernels to build a BVH and transmits those kernels to the accelerated processing device 116. A kernel is a shader program capable of being executed by the APD 116 in, for example, a SIMD manner. In some examples, the BVH builder 502 spawns one or more such kernels for the purpose of building a BVH, and causes the APD 116 to execute such one or more kernels. In some examples, the APD 116 executes such one or more kernels to generate at least a portion of a BVH and provide that BVH to the BVH builder 502. The BVH builder 502 then subsequently returns such BVH to the application 126 for subsequent processing (e.g., for rendering via ray tracing). It should be understood that although an example implementation of a BVH builder 502 is illustrated, any other technically feasible arrangement is possible. In an example, the BVH builder 502 is part of the application 126 which thus performs all operations described herein. In some examples, the BVH builder 502 is fully within the driver 122 which thus does not use the APD 116 to perform operations. In some examples, one or more portions of the BVH builder 502 is hardware accelerated, meaning that one or more circuits (e.g., digital circuits) performs one or more operations of the BVH builder 502. In some examples, the driver 122 does not return the BVH to the application 126 but instead performs ray tracing operations with the constructed BVH without additional communication from the application 126. In an example, the application provides scene geometry and requests ray tracing be performed with the scene geometry and the driver 122 builds the BVH and performs the requested rendering without returning the BVH to the application 126. In some examples, this functionality is present in the APD 116 instead of the driver 122, meaning that the driver 122 provides scene geometry and a request to perform ray tracing with the scene geometry and the APD 116 builds the BVH and performs the ray tracing. Any other technically feasible configuration is possible.

FIG. 6 is an illustration of an operation 600 for building a BVH, according to an example. The operation 600 occurs in a series of phases 602. These phases 602 include a nearest neighbor search phase 604 and a tree construction phase 606. In the nearest neighbor search phase 604, the BVH builder 502 searches for pairs of nearest neighbors from a set of candidate nearest neighbors. In FIG. 6, the candidates have bold outline. In some examples, a nearest neighbor pair is a pair of nodes where for each node, the other has a nearest neighbor metric that is above a threshold. In an example, the nearest neighbor metric is a surface area heuristic for the axis aligned bounding volume that bounds two candidate nodes. In some examples, the surface area heuristic for two nodes is the sum of the areas of the faces of the axis aligned bounding box that tightly bounds the geometry of the two nodes. In some examples, where the nodes are non-leaf nodes, an axis aligned bounding box “bounding the geometry for such a node” means that the axis aligned bounding box tightly bounds the bounding volume for both such nodes—in other words, the extents of the larger axis aligned bounding box bounds both bounding volumes for the nodes. In some examples, the threshold for the nearest neighbor metric is that for a first node, the surface area heuristic for that node and another node of the set is the lowest out of all pairs of nodes in the set of candidate nearest neighbors. In other words, given a node of a set of candidate nearest neighbors, another node of the set is considered to have a nearest neighbor metric that meets a threshold if the surface area heuristic for the first node and the second node is the lowest out of all combinations of the first node with any other node in the set. A nearest neighbor pair exists where there are two nodes where each such node has a nearest neighbor metric that meets a threshold with the other node. It should be understood that although an example technique for identifying nearest neighbors is provided, this should not be taken as limiting and any technically feasible technique for identifying nearest neighbors is possible.

As stated, the nearest neighbor search phase 604 evaluates a set of candidate nodes for nearest neighbors. In the event that at least one nearest neighbor pair is found in the set of candidate nodes for nearest neighbors, then the BVH builder 502 combines these found nearest neighbors by creating a new parent node with the two nearest neighbor nodes as children. It is possible for this search of a set of candidate nearest neighbors to indicate that there are no nearest neighbors in the set or that at least one node is not part of a nearest neighbor pair. In this case, any node that is not indicated as being part of a nearest neighbor pair is not combined until that node is determined to be a part of a nearest neighbor pair. In an example, it is possible for the set of candidate nearest neighbors that is considered in any particular nearest neighbor search to include nodes for which no nearest neighbor was found in a different phase 602. In other words, it is possible for the BVH builder 502 to determine that a particular node has no nearest neighbor pair in one phase 602 but then to change the set of candidate nearest neighbors in a different phase 602 and find a nearest neighbor pair for the above node in that different phase 602. In any event, the BVH builder 502 continues searching for nearest neighbors and generating the tree based on this search until a full BVH is built. Note that in any given nearest neighbor search 604, the set of candidate nearest neighbors does not need to be all uncombined nodes and can be a subset of the overall set of nodes under consideration.

Above it is stated that it is possible for the BVH builder 502 to not find a nearest neighbor pair for a particular node. In some examples, this means that the BVH builder 502 determined that the nearest neighbor for a first node does not agree with the nearest neighbor for a second node. In other words, the nearest neighbor for a first node is a second node, but the nearest neighbor for the second node is a third node. In an example, the BVH builder 502 (e.g., the nearest neighbor search phase 604) determines that, for a first node, the node whose surface area heuristic is the lowest is the second node, as that is the node for which the tightly fitting bounding box that bounds both nodes is smallest. However, using a similar determination, the BVH builder 502 determines that the corresponding node resulting in the smallest surface area heuristic is a third node. Thus the nearest neighbor for the first node and the second node do not agree and the BVH builder 502 has not found a nearest neighbor pair. By contrast, where two nodes agree on the nearest neighbor pair (e.g., that the nearest node for a first node is a second node and the nearest node for the second node is the first node), the BVH builder 502 has found a nearest neighbor pair.

In FIG. 6, the phases 602 are shown as alternating between one and the other but it should be understood that this particular ordering is only exemplary and is not necessarily how the BVH builder 502 will perform the operations 600 (e.g., the phases may occur in any order).

The example phases include phase 1 602(1), where the nearest neighbor search 604(1) searches for nearest neighbors with the illustrated nodes (6 small boxes). Based on the results of this search, the second phase 602(2) includes a tree construction phase 606(1) in which parents (larger boxes) are generated based on the found pairs as shown. In phase 3 602 (3), these parents are searched and in phase 602(4), an additional node is generated as shown.

FIG. 7 illustrates an example nearest neighbor search 700, according to an example. More specifically, the example nearest neighbor search 700 illustrates operations for performing a nearest neighbor search for a set of candidate nodes. Operation 710 illustrates a search operation for a single node and operation 720 illustrates operations for all nodes of the set of candidate nodes.

In operation 710, the BVH builder 502 searches for a nearest neighbor for one node. This search involves evaluating the combination of that node with each other node in the set of candidate nodes. In some examples, this evaluation includes generating a nearest neighbor metric for each such combination. In some examples, the nearest neighbor metric is a surface area heuristic. In some examples, the surface area heuristic for a combination of two nodes is the sum of the area of the faces of the axis-aligned bounding box that tightly bounds the geometry (e.g., the bounding box) of both nodes of the combination. In some examples, the result of the search of operation 510 is that the BVH builder 502 identifies which combination results in a nearest neighbor metric that meets a threshold. In some examples, this threshold is met for the combination that has the lowest surface area heuristic.

Operation 720 illustrates that the comparison of operation 710 is performed for each combination of the set of candidate nodes. In other words, for each node in the set of candidate nodes, the BVH builder 502 identifies the node for which the nearest neighbor metric meets the threshold (e.g., for which the surface area heuristic is lowest). The result is that for each node, there is an indication of which other node has a nearest neighbor metric that meets the threshold. A nearest neighbor pair results in the situation that there exists two nodes where each node indicates that the other node of the two nodes has a nearest neighbor metric that meets the threshold. For example, if a first node indicates that this is so for a second node, and the second node indicates that this is so for the first node, then the first node and the second node are part of a nearest neighbor pair. If, on the other hand, a first node indicates that a second node meets this condition, but the second node indicates that a third node, and not the first node, meets the condition, then the first node is not part of a nearest neighbor pair. The second and third node may still be part of a nearest neighbor pair if the third node indicates that the second node has a metric that meets the threshold. As can be seen, each nearest neighbor search involves multiple evaluations of one single node against all other nodes as described in operation 710. It is possible to perform these multiple operations in parallel, serially, or partially serially and partially in parallel.

The operation of performing the nearest neighbor search—operation 720—is performed by a machine learning model 730. In some examples, the machine learning model 730 is within a computer system such as the system 100 of FIG. 1. In some examples, the machine learning model 730. In some examples, the BVH builder 502 includes and/or implements the machine learning model 730. In some examples, the machine learning model 730 is implemented as instructions executed by one or more of the processor 102 or the APD 116, as well as data (e.g., weights) received by and processed by the machine learning model 730.

As stated above, the machine learning model 730 performs the nearest neighbor search 720 described above. Thus, the machine learning model 730 accepts, as input, data for the nodes (e.g. for each node of a set of candidate nearest neighbors) for which the search is performed and outputs data indicating nearest neighbor pairs. In some examples, the input data for each node is a bounding volume for that node. In some examples, this bounding volume is represented as six values—a minimum and maximum value in each of three coordinate axes, and each of these six values is provided to the machine learning model 730 as an input. In some examples, the output of the machine learning model 730 is an indication, for each node in the set of candidate nearest neighbors, of which other node meets the nearest neighbor threshold for that node. In some examples, it is possible for a candidate node, that the machine learning model 730 does not find a node that meets the nearest neighbor threshold, in which case the machine learning model 730 outputs an indication for the candidate node. In some examples, this indication is a value such as −1. In some examples, a nearest neighbor pair exists in the situation that the ML model 730 indicates, for a pair of nodes, that the other has a nearest neighbor metric that meets the threshold.

Although the ML model 730 can be implemented as any technically feasible architecture, in some examples, the ML model 730 is implemented as a multi-layer perceptron. In such an example, one or more inputs to the ML model 730 is associated with a particular node of the set of candidate nearest neighbors and each output of the ML model 730 is associated with a particular node of the input. In some examples, the set of nodes of the set of candidate nearest neighbors provides a different input to the neural network so that the neural network can provide output for all such nodes in parallel. Moreover, each output identifies which other node has a nearest neighbor metric that meets the threshold for the associated node, or if there is no such node, provides an indication that there is no such node.

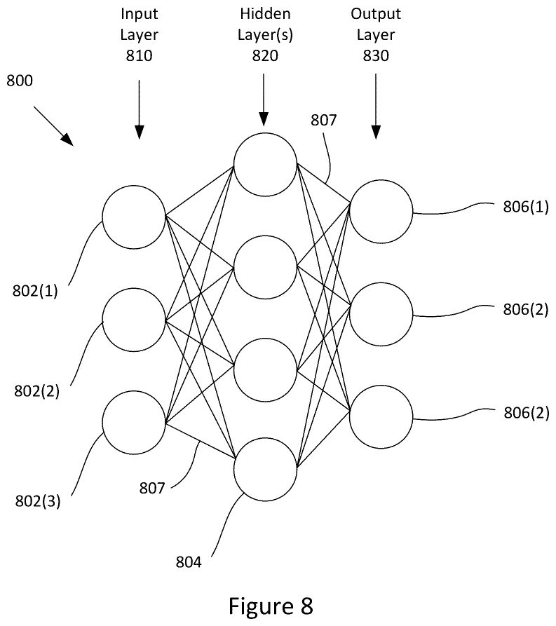

FIG. 8 illustrates an example machine learning model 800 that accepts candidate nearest neighbors and outputs information indicating nearest neighbor pairs, according to an example. The machine learning model 800 includes an input layer 810, a hidden layer 820, and an output layer 830. Each layer includes a set of neurons. The input layer 810 includes input neurons 802, the hidden layer 820 includes hidden layer neurons 804 and the output layer 830 includes output neurons 806. Each neuron has one or both of input connections 807 to one or more neurons of one or more other layers. For example, the input neurons 802 have connections 807 to the hidden layer neurons 804 and the output layer neurons 806 have connections 807 to the hidden layer neurons 804. Each connection 807 has a corresponding weight. For inference, the BVH builder 502 calculates an output value for a neuron based on the inputs and weights to that neuron. In an example, the output value for each such neuron is the sum of the products of the input value and weight value for each input connection for that neuron. In some examples, an additional function is applied to this weighted sum to produce an output, and in various other examples, any other technically feasible operation may be performed on the inputs to produce the outputs. Although one hidden layer 820 is illustrated, it should be understood that any number of hidden layers 820 could be present. In such situation, one such hidden layer 820 would accept as input inputs from the input layer 810 and provide outputs to either another hidden layer 820 or to the output layer 830. Further, although a specific number of neurons is shown in each layer, this number is exemplary and any technically feasible number could be present.

Each input neuron 802 of the machine learning model 800 corresponds to a particular node of an input set of candidate nearest neighbors. In some examples, one or multiple input neurons 802 correspond to the same node of the set. In some examples, each output node 806 is associated with, and thus provides an output value for, a particular node of the set of candidate nearest neighbors. In some examples, a pair of such output nodes 806 indicates that a nearest neighbor pair exists in the situation that the output neuron 806 for a first node of the pair indicates that a second node of the pair meets the nearest neighbor metric and the output neuron 806 for the second neuron of the pair indicates that the first node of the pair meets the nearest neighbor metric. In some examples, the position (e.g., index) of an input node corresponds to a position of a node in the candidate set of nearest neighbors, and similarly, the position of an output node corresponds to a position of a node in the candidate set of nearest neighbors. Thus, in such examples, the results for any given node of the set of candidate nodes depends on the order in which those nodes are provided to the multi layer perceptron 800, and an output for any given node in a candidate set is found at the corresponding output neuron 806.

In some examples, a training operation involves setting the weights based on training input. In some examples, the training input includes a set of training data items, where each set of training data items includes a plurality of inputs for a set of candidate nearest neighbors, where the data for each item of the set is expressed as a bounding volume, as well as a plurality of outputs, where each output includes an indication, for a corresponding node of the set, of the node that has a nearest neighbor metric that meets a threshold (or an indication that no such node exists). In other words, each input of a data item is associated with a node of the set and indicates a bounding volume. Each output of the data item includes an indication, for a corresponding node, of whether and which other node of the set has a nearest neighbor metric that meets the threshold. Applying these data items to the multi-layer perceptron 800 results in a trained multi-layer perceptron 800 that can produce the nearest neighbor results described above, given an input of bounding volumes for nodes of the set of candidate nearest neighbors. The training operation can be performed in any technically feasible system, such as the device 100 of FIG. 1, or in any other technically feasible computer system. In such a system, a processor executing training software would perform such training.

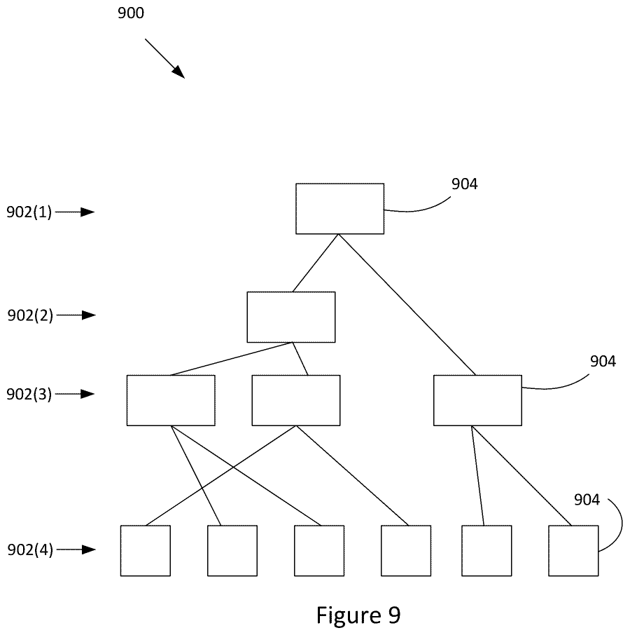

FIG. 9 illustrates an example BVH 900 built using techniques described herein. As shown, the BVH 900 includes four levels 902, each of which includes a set of one or more nodes 904. In an example, for each level, the BVH builder 502 invokes the ML model 730 to identify nearest neighbor pairs for that level in the nearest neighbor search phase 604 and then generates parents for the identified pairs in the tree construction phase 606.

In some examples, the BVH builder 502 quantizes the coordinates of the bounding volumes and provides those quantized bounding volumes to the ML model 730. In some examples, these quantized values are in fixed point, rather than floating point format, where fixed point format has a fixed increment between each adjacent representable value (for example, binary 0000 is 0.25 from 0001, and binary 1000 is also 0.25 from 1001). In some examples, the entire range of the fixed point space for any particular axis is determined by the minimum and maximum coordinates in each axis for the bounding volumes in a set of candidate nearest neighbors. In other words, each axis (x, y, or z) has its own fixed point space with the minimum representable value (e.g., 0000) being the minimum value for that axis across all bounding volumes of the candidate set of nearest neighbors and the maximum representable value (e.g., 1111) being the maximum value for that axis across all bounding volumes of the set. In some examples, each coordinate is “quantized” meaning that in the quantized representation, the quantized value assigned for any particular coordinate value is the closest value representable in the fixed point coordinate space. It should be understood that in such a system, the bitwise values for any given fixed point value is interpreted in light of the minimum and maximum values that define the range. For example, value 0000 does not necessarily mean “0” but means the lowest value in the range, and 1111 means the highest value in the range.

In some examples, the number of bits afforded to each value (e.g., each axis component for each of the minima and maxima for each bounding volume) depends on either the level of the bounding volume in the hierarchy or on the magnitude of the range of values in the set of candidate nearest neighbors. In one example, higher levels are provided with a greater number of bits for each value, and lower levels are provided with a lower number of bits. In one such example, the nearest neighbor search at level 902(3) is performed with 8 bits and the nearest neighbor search at level 902(4) is performed with 4 bits. In another example, a larger value range (e.g., greater difference between highest and lowest values) results in a larger number of bits used for the values in that range and a smaller value range results in a smaller number of bits. In other words, for a set of candidate nearest neighbors where the range of values in that set is relatively large, the BVH builder 502 utilizes a large number of bits to represent the corresponding quantized values and for a set of candidate nearest neighbors where the range is smaller than the above set, the BVH builder 502 utilizes a smaller number of bits to represent the corresponding quantized values. In an example, a first nearest neighbor search is performed with a first, larger number of bits because the first nearest neighbor search is at the top of a BVH being constructed or is performed for an overall bounding volume that has a larger range and a second nearest neighbor search for the same BVH is performed with a second smaller number of bits because the second nearest neighbor search is at a lower part of the BVH being constructed or is performed for an overall bounding volume that has a smaller range.

It should be understood that even though a certain number of nodes and levels is shown in FIG. 9, this is just an example and that any number, including a much large number, could be used.

It should be understood that using a number of bits for the fixed point representation for the machine learning operations means that the calculations for performing those operations occur with numbers having that number of bits. For example, additions and multiplications that occur (e.g., for weighting inputs and adding weighted inputs for neurons) occurs with numbers having that particular number of bits. Using a smaller number of bits for this representation means that fewer computing resources, such as processing resources, power, or other resources, are used, resulting in certain benefits. For example, the total power consumed is reduced and/or the total time taken for processing is reduced, since a smaller number of bits used per operation means that more such operations can be performed concurrently.

In some examples, the ML model 730 produces outputs not just for the nearest neighbors in the input set, but for the nearest neighbors of the nodes that would result once the nearest neighbors of the input set are combined (e.g., once parent nodes are generated). In other words, the ML model 730 produces nearest neighbors for multiple levels of a hierarchy. In the example of FIG. 9, a single application of the nodes at level 902(4) to the ML model 730 would result in the nearest neighbors for those nodes as well as for the nearest neighbors of the nodes of the level 902(3). A subsequent tree construction phase 606 would generate the tree as specified by the identification. Training for such a ML model 730 would include providing input training data items including the inputs identifying the bounding volumes and outputs including nearest neighbor identifications for multiple levels.

FIG. 10 is a flow diagram of a method 1000 for generating a BVH, according to an example. Although described with respect to the system of FIGS. 1-9, those of skill in the art will understand that any system configured to perform the steps of the method 1000 in any technically feasible order falls within the scope of the present disclosure.

At step 1002, the BVH builder 502 identifies nodes for which a nearest neighbor search is to be performed. In some examples, the BVH builder 502 is performing a bottom-up BVH build, starting with a bottom level of nodes and “combining” these nodes to generate parents. Each combining operation results in one or more new nodes that do not have parents. In an example, the identification comprises identifying any set of nodes of this BVH under construction for which such nodes have no parents. In some examples, the identification comprises identifying at most a certain fixed number of nodes that have no parents for the BVH under construction.

In some examples, the BVH builder 502 is not constructing a BVH from scratch but is instead replacing at least a portion of a pre-existing BVH. In this instance, the highest nodes that are not being replaced and under the portion of the BVH being replaced are considered to have no parents for the purpose of step 1002. In other words, where a sub-tree of a BVH is being replaced, the nodes directly under that sub-tree are considered to have no parents, since those parents are being replaced. Thus in that instance, step 1002 selects at least a portion of the nodes directly under the sub-tree is being replaced.

At step 1004, the BVH builder 502 applies data characterizing the identified nodes to a trained neural network (e.g., ML model 730) to obtain outputs identifying one or more nearest neighbors. In some examples, the data characterizing the identified nodes is data that indicates the minimum and maximum values for the bounding volume of each of the identified nodes. In some examples, this data is quantized (e.g., expressed in fixed-point) as described elsewhere herein. In some examples, the number of bits of the quantized representation is based on the level in the BVH of the nodes or based on the numerical range of the bounding volumes in the set. In some examples, the trained neural network is a multi-layer perceptron that accepts the data characterizing the identified nodes and generates indications of one or more nearest neighbors as output. More specifically, in some such examples, the output indicates, for each node, whether another node of the set has a nearest neighbor metric that meets a threshold. A nearest neighbor pair exists where, as described elsewhere herein, each of two nodes indicates that the other has a nearest neighbor metric that meets a threshold. In some examples, this operation generates outputs for multiple levels of a BVH.

At step 1006, the BVH builder 502 generates a tree structure based on the identified one or more nearest neighbors. In some examples, this operation includes generating a parent for each nearest neighbor pair, where the parent has, as its children, both nodes of the pair. In some examples, the bounding volume for the generated parent tightly bounds the geometry of both children. In some examples, where a node of the set of candidate nearest neighbors is not part of a nearest neighbor pair, that node is not combined by generating a new parent. In examples where the trained model generates results for multiple layers, the BVH builder 502 generates new parents for multiple layers of the BVH.

It should be understood that many variations are possible based on the disclosure herein. Although features and elements are described above in particular combinations, each feature or element can be used alone without the other features and elements or in various combinations with or without other features and elements.

The various functional units illustrated in the figures and/or described herein (including, but not limited to, the processor 102, the input driver 112, the input devices 108, the output driver 114, the output devices 110, the accelerated processing device 116, the scheduler 136, the compute units 132, the SIMD units 138, the ray tracing pipeline 300, including the ray generation shader 302, acceleration structure traversal stage 304, any hit shader 306, hit or miss unit 308, closest hit shader 310, miss shader 312, or BVH builder 502 may be implemented as a general purpose computer, a processor, a processor core, or in digital circuitry or analog circuitry, or as a program, software, or firmware, stored in a non-transitory computer readable medium or in another medium, executable by a general purpose computer, a processor, or a processor core. The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements features of the disclosure.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method comprising:
identifying one or more nodes for which a nearest neighbor search is to be performed;
applying data characterizing the one or more nodes to a neural network model to obtain outputs identifying one or more nearest neighbors; and
generating a portion of a bounding volume hierarchy (“BVH”) based on the one or more nearest neighbors.

2. The method of claim 1, wherein the identifying comprises identifying one or more nodes of the BVH that have no parent in the BVH.

3. The method of claim 1, wherein the neural network model comprises a multi-layer perceptron.

4. The method of claim 1, wherein the data characterizing the one or more nodes to the neural network model comprises one or more bounding volumes for the nodes.

5. The method of claim 4, wherein the data includes maxima and minima for each axis for the bounding volumes.

6. The method of claim 5, wherein the maxima and minima are quantized.

7. The method of claim 6, wherein the maxima and minima are in fixed point format.

8. The method of claim 7, wherein a number of bits in values of the fixed point format are dependent on a level in the BVH of the nodes or are based on ranges of the maxima and minima.

9. The method of claim 1, wherein the neural network provides outputs for multiple levels of the BVH for a single set of inputs.

10. A system comprising:
a memory configured to store a neural network model; and
a processor configured to perform operations comprising:
identifying one or more nodes for which a nearest neighbor search is to be performed;
applying data characterizing the one or more nodes to the neural network model to obtain outputs identifying one or more nearest neighbors; and
generating a portion of a bounding volume hierarchy (“BVH”) based on the one or more nearest neighbors.

11. The system of claim 10, wherein the identifying comprises identifying one or more nodes of the BVH that have no parent in the BVH.

12. The system of claim 10, wherein the neural network model comprises a multi-layer perceptron.

13. The system of claim 10, wherein the data characterizing the one or more nodes to the neural network model comprises one or more bounding volumes for the nodes.

14. The system of claim 13, wherein the data includes maxima and minima for each axis for the bounding volumes.

15. The system of claim 14, wherein the maxima and minima are quantized.

16. The system of claim 15, wherein the maxima and minima are in fixed point format.

17. The system of claim 16, wherein a number of bits in values of the fixed point format are dependent on a level in the BVH of the nodes or are based on ranges of the maxima and minima.

18. The system of claim 10, wherein the neural network provides outputs for multiple levels of the BVH for a single set of inputs.

19. A non-transitory computer-readable medium storing instructions that, when executed by a processor, cause the processor to perform operations comprising:
identifying one or more nodes for which a nearest neighbor search is to be performed;
applying data characterizing the one or more nodes to a neural network model to obtain outputs identifying one or more nearest neighbors; and
generating a portion of a bounding volume hierarchy (“BVH”) based on the one or more nearest neighbors.

20. The non-transitory computer-readable medium of claim 19, wherein the identifying comprises identifying one or more nodes of the BVH that have no parent in the BVH.
